(19) United States
(12) Patent Application Publication
(10) Pub. No.: US 2026/0078716 A1
(43) Pub. Date: Mar. 19, 2026

(54) INTERNALLY DIFFUSING HEAT EXCHANGER FOR A GAS TURBINE ENGINE

(71) Applicant: General Electric Company, Evendale, OH (US)

(72) Inventors: Brandon Wayne Miller, Middletown, OH (US); Daniel Lawrence Tweedt, West Chester, OH (US); Lawrence William Nurre, West Chester, OH (US); Syed Arif Khalid, West Chester, OH (US)

(21) Appl. No.: 18/828,366

(22) Filed: Sep. 9, 2024

(51) Int. Cl. F02K 3/115

(52) U.S. Cl. CPC F02K 3/115; F05D 2260/213; F05D 2260/22141

(57) ABSTRACT

A heat exchanger includes an outer body defining a centerline axis and a flow passage extending from an inlet to an outlet of the heat exchanger. A first annular fin is disposed within the flow passage, wherein the first annular fin is concentrically aligned with the centerline axis and defines a first undulating surface. A second annular fin is disposed within the flow passage. The second annular fin is concentrically aligned with the centerline axis and defines a second undulating surface. The second annular fin is radially spaced from the first annular fin to define a flow channel therebetween. The flow passage, the first annular fin, and the second annular fin diverge along the centerline axis downstream from the inlet.

### FIELD

The present disclosure relates to a heat exchanger for a gas turbine engine. More particularly, this disclosure is directed to an internally diffusing heat exchanger with particularly shaped surfaces.

### BACKGROUND

It can be desirable to introduce a heat exchanger into a primary or secondary flowpath of a gas turbine engine. For example, heat exchangers may be used for purposes such as intercooling, waste heat recovery, anti-icing/de-icing, improving cycle thermal efficiency or operability, or thermal management. High velocities within the heat exchanger generate high pressure losses. If pressure losses are sufficiently high, they can exceed system efficiency gains provided by the heat exchanger, resulting in a net reduction in system efficiency.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a perspective view of an exemplary aircraft in accordance with an exemplary embodiment of the present disclosure.

FIG. 2 is a cross-sectional schematic view of a gas turbine engine in accordance with an exemplary aspect of the present disclosure.

FIG. 3 provides a schematic cross-sectional illustration of a structure of an exemplary embodiment of a heat exchanger, according to embodiments of the present disclosure.

FIG. 4 provides a cross-sectional schematic side view of an exemplary heat exchanger including a heat transfer assembly, according to various embodiments of the present disclosure.

FIG. 5 provides an upstream looking view from an aft end of the heat transfer assembly as shown in FIG. 3, according to exemplary embodiments of the present disclosure.

FIG. 6 provides a perspective view of a portion of the of the heat transfer assembly as shown in FIG. 3, according to exemplary embodiments of the present disclosure.

FIG. 7 provides a schematic view representative of either an upstream end or a downstream end of a portion of the heat transfer assembly, according to exemplary embodiments of the present disclosure.

FIG. 8 provides a cross-sectional schematic side view of an exemplary heat exchanger including an exemplary heat transfer assembly, according to an embodiment of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration. ” Any implementation described herein as “exemplary” is not necessarily to be construed as preferred or advantageous over other implementations. Additionally, unless specifically identified otherwise, all embodiments described herein should be considered exemplary.

As used herein, the terms “first”, “second”, and “third” may be used interchangeably to distinguish one component from another and are not intended to signify location or importance of the individual components.

The terms “forward” and “aft” refer to relative positions within a gas turbine engine or aircraft and refer to the normal operational attitude of the gas turbine engine or aircraft. For example, with regards to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

It will be appreciated that as used herein, the terms “high/low speed” and “high/low-pressure” are used with respect to the high-pressure/high speed system and low-pressure/low speed system interchangeably. Further, it will be appreciated that the terms “high” and “low” are used in this same context to distinguish between two systems and are not meant to imply any absolute speed and/or pressure values.

A “third stream” as used herein means a non-primary air stream capable of increasing fluid energy to produce a minority of total propulsion system thrust. A pressure ratio of the third stream may be higher than that of the primary propulsion stream (e.g., a bypass or propeller driven propulsion stream). The thrust may be produced through a dedicated nozzle or through mixing of an airflow through the third stream with a primary propulsion stream or a core air stream, e.g., into a common nozzle.

The following disclosure is directed to a heat exchanger for a gas turbine engine. More particularly, the disclosure is directed to a heat exchanger including a plurality of annular or sleeve shaped fins with undulated surfaces to diffuse air radially. This configuration facilitates a much lower Mach number through the heat exchanger which in turn reduces air side pressure drop. Enhancements can be imagined where the circumferential vane leading and trailing edges are staggered to reduce entrance and exit blockage. The undulated surfaces progress around and along the heat exchanger centerline axis. These undulated surfaces may extend fully about the entire circumference of the fins or may be limited to a segment of the fins. This can also be further enhanced by making the leading and trailing edges serrated, or otherwise shaped, such that they appear like exhaust nozzle chevrons, this again reduces nozzle entrance and exit loss effects. The leading and trailing edges may have a common shape and size or may be of varying shapes and sizes. The serrated leading and trailing edges may be disposed about the entire circumference of the fins or may be limited to a segment of the fins. Each of these features may be combined into a single heat exchanger to provide maximum heat transfer with minimum air side pressure drop.

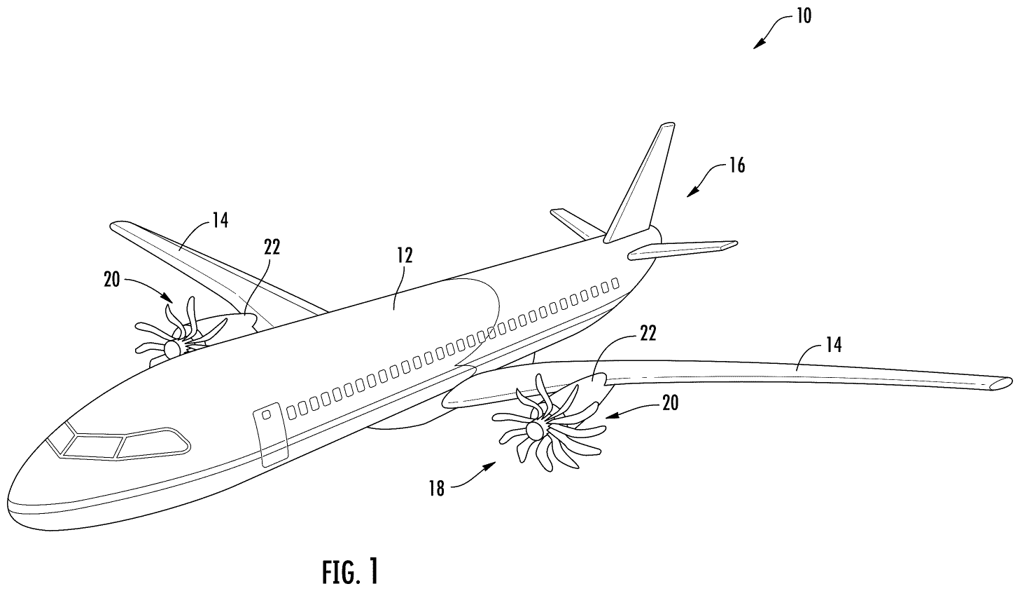

Referring now to the drawings, FIG. 1 is a perspective view of an exemplary aircraft 10 that may incorporate at least one exemplary embodiment of the present disclosure. As shown in FIG. 1, the aircraft 10 has a fuselage 12, wings 14 attached to the fuselage 12, and an empennage 16. The aircraft 10 further includes a propulsion system 18 that produces a propulsive thrust to propel the aircraft 10 in flight, during taxiing operations, etc. Although the propulsion system 18 is shown attached to the wings 14, in other embodiments it may additionally or alternatively include one or more aspects coupled to other parts of the aircraft 10, such as, for example, the empennage 16, the fuselage 12, etc.

The propulsion system 18 includes at least one engine. In the exemplary embodiment shown, the aircraft 10 includes a pair of gas turbine engines 20. In particular embodiments, each gas turbine engine 20 is mounted to the aircraft 10 in an under-wing configuration via a respective pylon 22. Each gas turbine engine 20 is capable of selectively generating a propulsive thrust for the aircraft 10. It is to be appreciated that the gas turbine engines 20 may also be mounted in other locations of the aircraft such as but not limited to the empennage 16. In addition, the gas turbine engines 20 may be configured to burn various forms of fuel including, but not limited to unless otherwise provided, jet fuel/aviation turbine fuel, and hydrogen fuel.

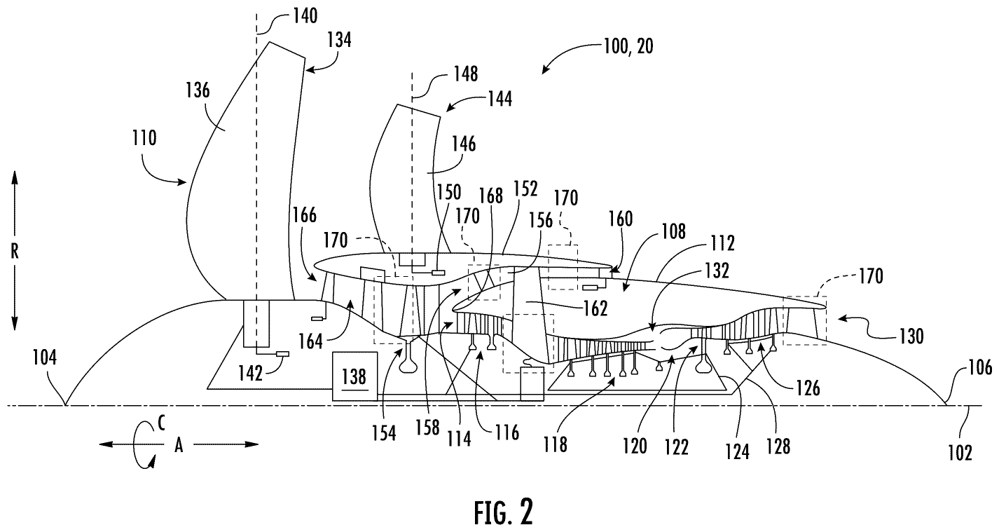

FIG. 2 is a schematic cross-sectional view of a gas turbine engine 100 which may be exemplary of the gas turbine engine 20 as shown in FIG. 1, according to an example embodiment of the present disclosure. Particularly, FIG. 2 provides a turbofan engine having a rotor assembly with a single stage of unducted rotor blades. In such a manner, the rotor assembly may be referred to herein as an “unducted fan,” or the gas turbine engine 100 may be referred to as an “unducted turbofan engine.” In addition, the gas turbine engine 100 of FIG. 2 includes a third stream extending from the compressor section to a rotor assembly flowpath over the turbomachine, as will be explained in more detail below.

It should be appreciated, however, that the exemplary gas turbine engine 100 depicted in FIG. 2 is provided by way of example only, and that in other exemplary embodiments, the gas turbine engine 100 may have other configurations. For example, although the gas turbine engine 100 depicted is configured as a single unducted rotor engine, in other embodiments, the gas turbine engine 100 may be a ducted gas turbine engine (e.g., including an outer nacelle), or a multi-stage open rotor configuration. In other exemplary embodiments, aspects of the present disclosure may (as appropriate) be incorporated into, e.g., a turboprop gas turbine engine, a turboshaft gas turbine engine, or a turbojet gas turbine engine.

For reference, the gas turbine engine 100 defines an axial direction A, a radial direction R, and a circumferential direction C. Moreover, the gas turbine engine 100 defines an axial centerline or longitudinal axis 102 that extends along the axial direction A. In general, the axial direction A extends parallel to the longitudinal axis 102, the radial direction R extends outward from and inward to the longitudinal axis 102 in a direction orthogonal to the axial direction A, and the circumferential direction extends three hundred sixty degrees (360°) around the longitudinal axis 102. The gas turbine engine 100 extends between a forward end 104 and an aft end 106, e.g., along the axial direction A.

As shown in FIG. 2, the gas turbine engine 100 includes a turbomachine 108 having a fan section 110 that is positioned upstream thereof. The turbomachine 108 also includes a core cowl 112 that defines an annular core inlet 114 to a booster or low-pressure compressor 116 for pressurizing the air that enters the turbomachine 108 through annular core inlet 114. A high-pressure compressor 118 is disposed downstream from the low-pressure compressor 116 to receive the pressurized air and further increases the pressure of the air. The pressurized air stream flows downstream from the high-pressure compressor 118 to a combustor 120 of the combustion section where fuel is injected into the pressurized air stream and ignited to raise the temperature and energy level of the pressurized air.

High energy combustion products flow from the combustor 120 downstream to a high-pressure turbine 122. The high-pressure turbine 122 drives the high-pressure compressor 118 via a high-pressure shaft 124 drivingly coupled with the high-pressure compressor 118. The high energy combustion products then flow to a low-pressure turbine 126. The low-pressure turbine 126 drives the low-pressure compressor 116 and components of the fan section 110 via a low-pressure shaft 128 drivingly coupled with the low-pressure compressor 116 and components of the fan section 110. The low-pressure shaft 128 is coaxial with the high-pressure shaft 124 in this example embodiment. After driving each of the high-pressure turbine 122 and the low-pressure turbine 126, the combustion products exit the turbomachine 108 through a turbomachine exhaust nozzle 130.

Accordingly, the turbomachine 108 defines a working gas flowpath or core duct 132 that extends between the annular core inlet 114 and the turbomachine exhaust nozzle 130. The core duct 132 is an annular duct positioned generally inward of the core cowl 112 along the radial direction R. The core duct 132 (e.g., the working gas flowpath through the turbomachine 108) may be referred to as a second stream.

The fan section 110 includes a fan 134, which is the primary fan in this example embodiment. For the depicted embodiment of FIG. 2, the fan 134 is an open rotor or unducted fan. In such a manner, the gas turbine engine 100 may be referred to as an open rotor engine.

As depicted, the fan 134 includes a plurality or an array of fan blades 136 (only one shown in FIG. 2). The fan blades 136 are rotatable, e.g., about the longitudinal axis 102. As noted above, the fan 134 is drivingly coupled with the low-pressure turbine 126 via the low-pressure shaft 128. For the embodiments shown in FIG. 2, the fan 134 is coupled with the low-pressure shaft 128 via a speed reduction gearbox 138, e.g., in an indirect-drive or geared-drive configuration. Each fan blade 136 defines a central blade axis 140. For this embodiment, each fan blade 136 of the fan 134 may be rotatable about its central blade axis 140, e.g., in unison with one another via one or more first actuators 142.

The fan section 110 further includes a fan guide vane array 144 that includes fan guide vanes 146 (only one shown in FIG. 2) disposed around the longitudinal axis 102. For this embodiment, the fan guide vanes 146 are not rotatable about the longitudinal axis 102. Each fan guide vane 146 has a root and a tip and a span defined therebetween. The fan guide vanes 146 may be unshrouded as shown in FIG. 2 or, alternatively, may be shrouded, e.g., by an annular shroud spaced outward from the tips of the fan guide vanes 146 along the radial direction R or attached to the fan guide vanes 146.

Each fan guide vane 146 defines a central blade axis 148. For this embodiment, each fan guide vane 146 of the fan guide vane array 144 is rotatable about its central blade axis 148, e.g., in unison with one another via one or more second actuators 150. In alternate configurations, each fan guide vane 146 may be fixed or unable to be pitched about its central blade axis 148. The fan guide vanes 146 may be mounted to a fan cowl 152.

As shown in FIG. 2, in addition to the fan 134, which is unducted, a ducted fan 154 is included aft of the fan blades 136, such that the gas turbine engine 100 includes both a ducted and an unducted fan which both serve to generate thrust through the movement of air without passage through at least a portion of the turbomachine 108 (e.g., without passage through the high-pressure compressor 118 and combustion section for the embodiment depicted). The ducted fan 154 is rotatable about the same axis (e.g., the longitudinal axis 102) as the fan blades 136. The ducted fan 154 is, for the embodiment depicted, driven by the low-pressure turbine 126 (e.g., coupled to the low-pressure shaft 128). The ducted fan 154 includes a plurality of fan blades (not separately labeled in FIG. 2) arranged in a single stage, such that the ducted fan 154 may be referred to as a single stage fan. The fan blades of the ducted fan 154 can be arranged in equal circumferential spacing around the longitudinal axis 102. In the embodiment depicted, as noted above, the fan section 110 may be referred to as the primary fan, and the ducted fan 154 may be referred to as a secondary fan. It will be appreciated that these terms “primary” and “secondary” are terms of convenience, and do not imply any particular importance, power, or the like.

The fan cowl 152 annularly encases at least a portion of the core cowl 112 and is generally positioned outward of at least a portion of the core cowl 112 along the radial direction R. Particularly, a downstream section of the fan cowl 152 extends over a forward portion of the core cowl 112 to define a fan duct flowpath, or simply a fan duct 156. According to this embodiment, the fan flowpath or fan duct 156 may be understood as forming at least a portion of the third stream of the gas turbine engine 100.

Incoming air may enter through the fan duct 156 through a fan duct inlet 158 and may exit through a fan exhaust nozzle 160 to produce propulsive thrust. The fan duct 156 is an annular duct positioned generally outward of the core duct 132 along the radial direction R. The fan cowl 152 and the core cowl 112 are connected together and supported by a plurality of substantially radially extending and circumferentially spaced stationary struts 162 (only one shown in FIG. 2).

The gas turbine engine 100 shown in FIG. 2 also defines or includes an inlet duct 164. The inlet duct 164 extends between an engine inlet 166 and the annular core inlet 114 and fan duct inlet 158. The engine inlet 166 is defined generally at the forward end of the fan cowl 152 and is positioned between the fan section 110 and the fan guide vane array 144 along the axial direction A. The inlet duct 164 is an annular duct that is positioned inward of the fan cowl 152 along the radial direction R. Air flowing downstream along the inlet duct 164 is split, not necessarily evenly, into the core duct 132 and the fan duct 156 by a fan duct splitter or a leading edge 168 of the core cowl 112. In the embodiment depicted, the inlet duct 164 is wider than the core duct 132 along the radial direction R. The inlet duct 164 is also wider than the fan duct 156 along the radial direction R.

In exemplary embodiments, the gas turbine engine 100 includes one or more heat exchangers. Exemplary locations of heat exchanger(s) are shown schematically by boxes labeled 170. For example, the heat exchanger(s) may be configured to mount within a flow duct or flow path of the gas turbine engine 100, such as but not limited to the core duct 132, the fan duct 156, the inlet duct 164, the fan exhaust nozzle 160, or within the turbomachine exhaust nozzle 130.

The heat exchanger(s) described herein are particularly suitable for use with a flowpath that is intolerant to flow losses. While flow losses are undesirable, the term “intolerant to flow losses” as used herein refers to a flowpath in which undesirable effects caused by flow losses would outweigh the desirable effects of the heat transfer. This would generally be a flowpath having a flow with a Mach number greater than about 0.3. Nonlimiting examples of such a flowpath would include: a heat exchanger used as an intercooler in the core duct 132 between the low-pressure compressor 116 and the high-pressure compressor 118, a heat exchanger communicating in the inlet duct 164, a heat exchanger communicating with the fan duct 156, and a heat exchanger communicating with the low-pressure turbine 126 used as a cooler or recuperator.

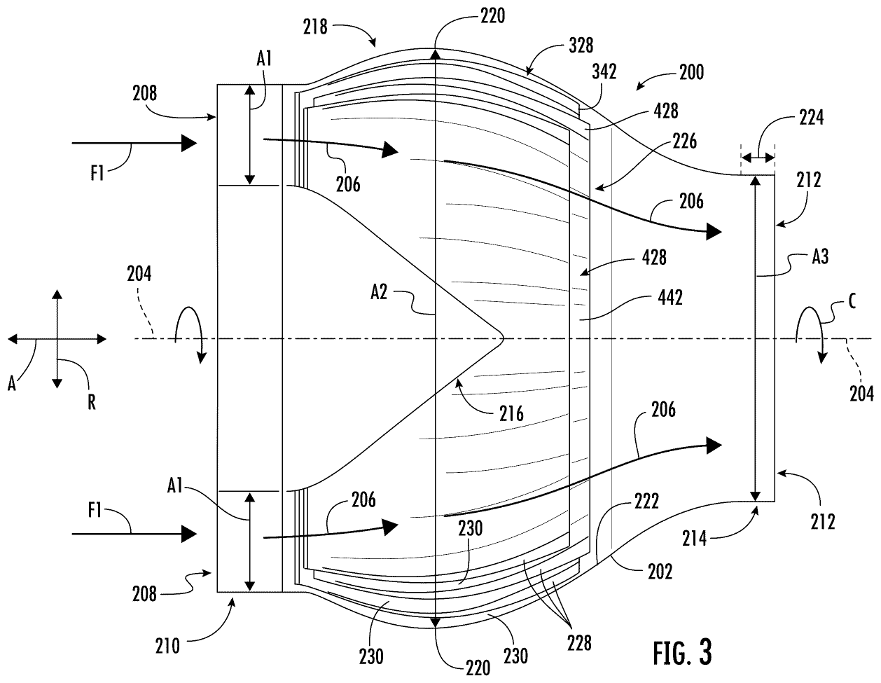

FIG. 3 provides a schematic cross-sectional illustration of the structure of an exemplary embodiment of a heat exchanger 200. The heat exchanger 200 includes an outer body 202 having a centerline axis 204 and defining a flow passage 206 therethrough. The centerline axis 204 extends in an axial direction (A). Radial direction (R) is defined outward from the centerline axis 204. The heat exchanger 200 includes an inlet 208 disposed at an upstream end 210 of the outer body 202 and an outlet 212 defined at a downstream end 214 of the outer body 202. The flow passage 206 fluidly couples the inlet 208 to the outlet 212 for routing a first fluid (F1) through the heat exchanger 200. In one example, the first fluid F1 may be a working fluid of the gas turbine engine 100, such as compressed air or combustion products. In exemplary embodiments, the heat exchanger 200 includes a diffuser body 216 or nozzle that extends within the flow passage 206 along the centerline axis 204.

As shown in FIG. 3, the heat exchanger 200 includes a diverging portion 218 defined downstream of the inlet 208 and upstream of the outlet 212. When present, the diffuser body 216 may extend at least partially into or through the diverging portion 218 along the centerline axis 204. Within the diverging portion 218, the outer body 202 diverges radially outwardly with respect to centerline axis 204. Described in another way, the outer body 202 bulges outwards or has a bulbous shape between the inlet 208 and the outlet 212 with respect to the centerline axis 204. A location downstream of the inlet 208 and upstream of the outlet 212 where the outer body 202 reaches a maximum radial dimension with respect to the centerline axis 204 is referred to herein as a “belly” 220.

The flow passage 206 has a first flow area designated “A1” at the inlet 208. The flow passage 206 has a second flow area designated “A2” at the belly 220. The flow passage 206 has a third flow area designated “A3” at the outlet 212. The second flow area A2 is greater than the first flow area A1, thus defining a diffuser. The ratio of the flow areas A2/A1 and the axial or streamwise rate of change between the two, that is, the profile shape of an inner wall 222 of the heat exchanger 200 (“diffusion rate”), may be selected to suit a specific application. As one example, the flow area A2/A1 may be selected to achieve a desired Mach number of the first fluid F1 at the belly 220 given a specific inlet Mach number. For example, the Mach number at the inlet 208 might be approximately 0.5 and could be approximately for example about 0.2 at the belly 220. The flow area A2 at the belly 220 may be much greater than the flow area A1. In one example, the flow area A2 could be at least 30% greater than the flow area A1. In another example, the flow area A2 could be at least 50% greater than the flow area A1. In yet another example, the flow area A2 could be at least 100% greater than the flow area A1.

In the illustrated example, the third flow area A3 is less than the second flow area A2, thus defining a nozzle or converging portion. In other words, the flow passage 206 converges downstream from the belly 220 and upstream from the outlet 212. The ratio of the flow areas A3/A2 and the rate of change between the two, that is, the profile shape of the outer body 202, may be selected to suit a specific application. For example, if the Mach number at the inlet is approximately 0.5 and is approximately for example about 0.2 at the belly 220, the nozzle could be configured to re-accelerate the flow of the first fluid F1 to approximately Mach 0.5 at the outlet 212. It is to be noted that the nozzle is desirable for certain applications but is not required to achieve the functional benefit of the heat exchanger 200. Also, it is noted that a section of constant area 224 (neither diffusing nor accelerating) may be positioned downstream of the belly 220.

In exemplary embodiments, the heat exchanger 200 includes the heat transfer assembly 226. As shown in FIG. 3, the heat transfer assembly 226 generally includes a plurality of annular fins 228 disposed within the flow passage 206. In the illustrated embodiment, the heat transfer assembly 226, more particularly, the plurality of annular fins 228 includes three annular fins 228, however, it is to be appreciated that the plurality of annular fins 228 may include any number of annular fins greater than two. The plurality of annular fins 228 extends in axial direction A and is concentrically aligned with the centerline axis 204. Each annular fin 228, of the plurality of annular fins 228, is spaced radially apart (in the radial direction R) from a respective radially adjacent annular fin 228 of the plurality of annular fins 228 to form a flow channel 230 therebetween. The plurality of annular fins 228 collectively subdivides the flow passage 206 into a plurality of flow channels 230 which extend in the axial direction A and the radial direction R within the flow passage 206 in a generally parallel manner.

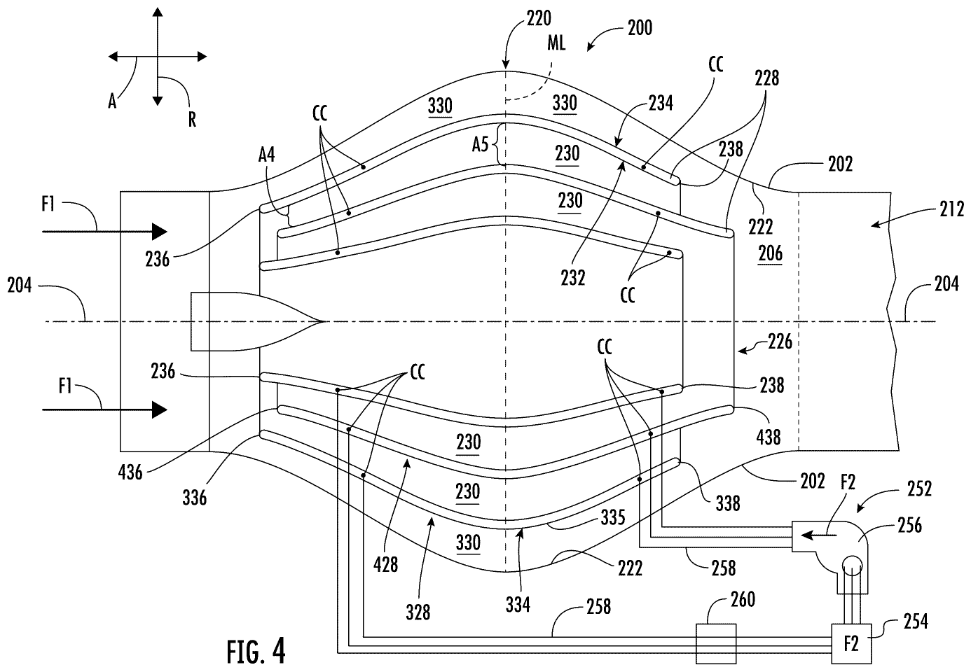

FIG. 4 provides a cross-sectional schematic side view of the heat exchanger 200 including the heat transfer assembly 226, according to various embodiments of the present disclosure. As shown in FIG. 4, each annular fin 228 has an inner wall 232 radially spaced from an outer wall 234 and extending between a leading edge 236 and a trailing edge 238 of the respective radially adjacent annular fin 228.

As shown in FIG. 4, each flow channel 230 has a flow area at its upstream end, designated “A4”, and a flow area at the belly 220, designated “A5”. The plurality of annular fins 228 are each configured such that each flow channel 230 acts as a diffuser, or stated another way the flow area A5 is greater than the flow area A4. Analysis has shown that it is beneficial for reducing flow losses if the flow channels 230 are configured so as to have similar or equal diffusion ratios, or stated another way, for the ratio A5/A4 to be approximately equal for each flow channel 230. It is also beneficial for reducing flow losses if the flow channels 230 are configured so as to have similar or equal diffusion rates as defined above.

In exemplary embodiments, the plurality of annular fins 228 are shaped and sized so as to act as turning vanes, that is to turn or guide the flow of the first fluid F1 in an axial-radial plane in a manner so as to prevent flow separation from the wall surfaces. The plurality of annular fins 228 may present area blockage of the flow passage 206 equal to a sum total of a frontal area of the plurality of annular fins 228.

As shown in FIG. 4, in order to mitigate the effect of the area blockage, the leading edges 236 of the respective radially adjacent annular fins 228 may be arranged in a staggered or axially offset configuration. For example, in the illustrated embodiment, the plurality of annular fins 228 includes a first annular fin 328 disposed within the flow passage 206 and radially adjacent to the inner wall 222 of the outer body 202. The plurality of annular fins 228 further includes a second annular fin 428 which is disposed within the flow passage 206 radially inward from and adjacent to the first annular fin 328. The first annular fin 328 defines a radially outer wall 334 defining a radially outer surface 335. A second flow channel 330 is defined between the radially outer wall 334 outer surface 335 and the inner wall 222 of the outer body 202. The second flow channel 330 diverges between a first leading edge 336 of the first annular fin and the belly 220.

In particular embodiments, the first leading edge 336 of the first annular fin 328 may be positioned the most upstream or axially forward of a midline (ML) of the outer body 202, with a second leading edge 436 of the second annular fin 428, or any other annular fin 228 of the plurality of annular fins 228, being axially offset or biased towards or closer to the midline (ML) of the outer body 202. The effect of the staggered annular fin location described above is that flow of the first fluid F1 is diffusing as it proceeds downstream from the inlet 208 to the belly 220.

In addition, or in the alternative, the respective trailing edges 238 of the annular fins 228 may be arranged in a staggered or axially offset configuration. For example, in the illustrated embodiment, the first trailing edge 338 of the first annular fin 328 may be positioned upstream (or downstream) of a second trailing edge 438 of the second annular fin 428 or any other annular fin 228 of the plurality of annular fins 228.

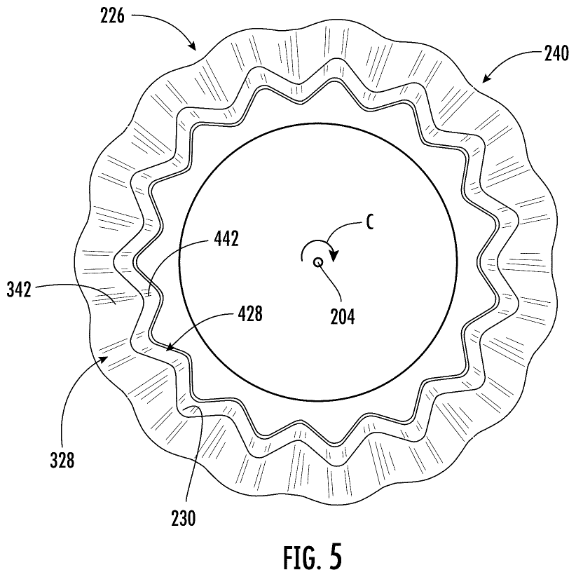

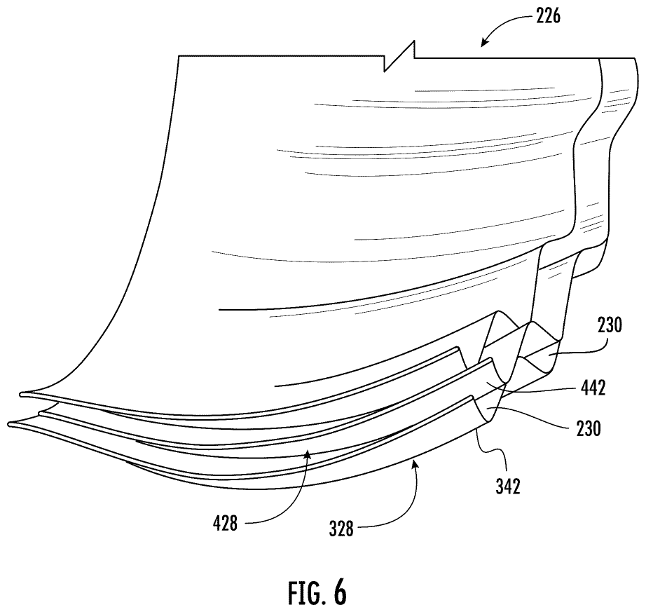

FIG. 5 provides an upstream looking view from an aft end 240 of the heat transfer assembly 226 according to exemplary embodiments of the present disclosure. FIG. 6 provides a perspective view of a portion of the of the heat transfer assembly 226, according to an exemplary embodiment of the present disclosure. As shown in FIGS. 5 and 6 collectively, the first annular fin 328 is undulated thus defining a first undulating surface 342 and the second annular fin 428 is undulated thus defining a second undulating surface 442. In other words, the first annular fin 328 and the second annular fin 428 have a wavy or curved form. The first undulating surface 342 and the second undulating surface 442 are similarly formed or conformed to each other to match and are radially spaced to maintain unencumbered flow through the respective flow channel 230 defined therebetween.

In one embodiment, as shown in FIGS. 3 and 5, the first undulating surface 342, and the second undulating surface 442 are undulated in a circumferential direction (C) about the centerline axis 204 about a circumference of the first annular fin 328 and the second annular fin 428. The first undulating surface 342 is aligned circumferentially and axially with the second undulating surface 442 with respect to the centerline axis 204.

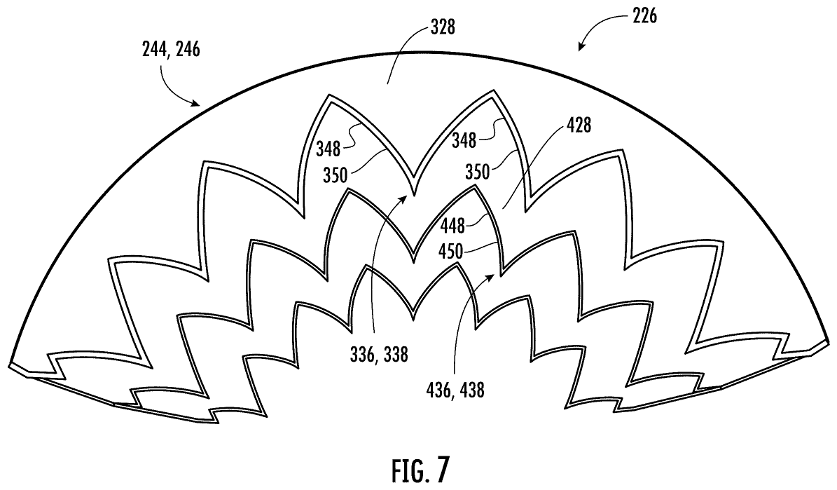

FIG. 7 provides a schematic view of a portion of the heat transfer assembly 226 according to exemplary embodiments of the present disclosure. The portion of the heat transfer assembly shown in FIG. 7 may be representative of either an upstream end 244 or a downstream end 246 of the heat transfer assembly 226. In particular embodiments, wherein FIG. 7 is representative of the upstream end 244, at least one of the first leading edge 336 of the first annular fin 328 and the second leading edge 436 of the second annular fin 428 defines a plurality of circumferentially adjoining chevrons 348, 448 respectively. In particular embodiments, wherein FIG. 7 is representative of the downstream end 246, at least one of the first trailing edge 338 of the first annular fin 328 and the second trailing edge 438 of the second annular fin 428 defines a plurality of circumferentially adjoining chevrons 350 and 450 respectively. The chevron 348, 448 may be similarly shaped or may have varying shapes and sizes (axial lengths), may be disposed 360 degrees about the first leading edge 336 of the first annular fin 328 and the second leading edge 436 of the second annular fin 428 or may be segmented about the first leading edge 336 of the first annular fin 328 and the second leading edge 436 of the second annular fin 428 instead of 360 degrees.

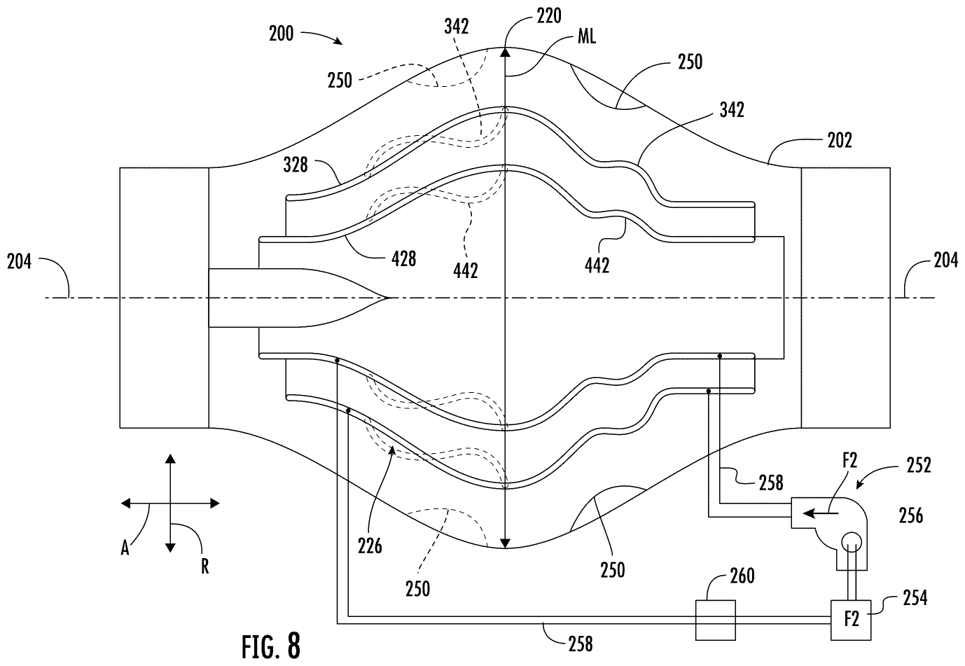

FIG. 8 provides a cross-sectional schematic side view of the heat exchanger 200 including the heat transfer assembly 226, according to another embodiment of the present disclosure. As shown in FIG. 8, one or more of the first annular fin 328 and thus the first undulating surface 342 and the second annular fin 428 and thus the second undulating surface 442, may be undulated in the axial direction A with respect to the centerline axis 204. The first annular fin 328 and thus the first undulating surface 342 and the second annular fin 428 and thus the second undulating surface 442, may be undulated in the axial direction A upstream from (as shown in dashed lines) or downstream from the belly 220 defined at the mid-line ML of the outer body 202.

In particular embodiments, the first annular fin 328 and thus the first undulating surface 342 and the second annular fin 428 and thus the second undulating surface 442, may be undulated in the axial direction A both upstream from (as shown in dashed lines) and downstream from the belly 220 defined at the mid-line ML of the outer body 202. In particular embodiments, the inner wall 222 of the outer body 202 may include surface features 250 extending in the axial A and radial direction R to conform with the first undulating surface 342.

In exemplary embodiments, as illustrated in FIGS. 4 and 8, one more of the annular fins 228 of the plurality of annular fins 228 may comprise one or more channels or cooling circuits (CC) for conducting flow of a second fluid (F2) (e.g. oil, fuel or some other coolant) via a coolant system 252 through one or more of the annular fins 228 of the plurality of annular fins 228. The coolant system 252 may include a thermal fluid source 254, a pump 256, and various conduits/piping 258 for fluidly coupling one more of the annular fins 228 of the plurality of annular fins 228 to the coolant system 252. The second fluid F2 may be maintained at a desired temperature by various means. For example, the second fluid F2 could be circulated through a remote heat exchanger 260 in order to cool it.

In operation, the first fluid flows through the flow passage 206 and through the flow channels 230 and over the plurality of annular fins 228. The second fluid F2 circulates through the annular fins 228. The second fluid F2 may be a coolant supplied at a lower temperature than the first fluid F1. Depending upon the relative temperatures of the first and second fluids F1, F2, heat is transferred either from the first fluid F1 into the annular fins 228, then to the second fluid F2, or from the second fluid F2 into the annular fins 228, then to the first fluid F1. As the first fluid F1 flows from the inlet 208 to the belly 220, it diffuses, reducing its velocity and increasing its static pressure. The plurality of annular fins 228 act as turning vanes, as well as diffuser walls, allowing the first fluid F1 to diffuse without separating from the inner wall 222 or the respective inner wall 232 and outer wall 234 which form each respective flow channel 230. As the first fluid F1 passes downstream, it is re-accelerated to an appropriate Mach number for the downstream flowpath.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

A heat exchanger, comprising: an outer body defining a centerline axis and a flow passage extending from an inlet to an outlet of the heat exchanger; a first annular fin disposed within the flow passage, wherein the first annular fin is concentrically aligned with the centerline axis and defines a first undulating surface; and a second annular fin disposed within the flow passage, wherein the second annular fin is concentrically aligned with the centerline axis and defines a second undulating surface, wherein the second annular fin is radially spaced from the first annular fin to define a flow channel therebetween, and wherein the flow passage, the first annular fin, and the second annular fin diverge along the centerline axis downstream from the inlet.

The heat exchanger of the preceding or any following clause, wherein the outer body is bulbous shaped between the inlet and the outlet.

The heat exchanger of any preceding or any following clause, wherein the first undulating surface is aligned circumferentially and axially with the second undulating surface with respect to the centerline axis.

The heat exchanger of any preceding or any following clause, wherein the first undulating surface and the second undulating surface are undulated in an axial direction with respect to the centerline axis.

The heat exchanger of any preceding or any following clause, wherein the first undulating surface and the second undulating surface are undulated in a circumferential direction with respect to the centerline axis.

The heat exchanger of any preceding or any following clause, wherein the first annular fin and the second annular fin are formed to turn flow of a first fluid through the flow channel about the centerline axis.

The heat exchanger of any preceding or any following clause, wherein the first annular fin defines a first leading edge, and the second annular fin defines a second leading edge, wherein the first leading edge is axially offset from the second leading edge with respect to the centerline axis.

The heat exchanger of any preceding or any following clause, wherein the first annular fin defines a first leading edge, and the second annular fin defines a second leading edge, wherein at least one of the first leading edge and the second leading edge defines a plurality of circumferentially adjoining chevrons.

The heat exchanger of any preceding or any following clause, wherein the first annular fin defines a first trailing edge, and the second annular fin defines a second trailing edge, wherein the first trailing edge is axially offset from the second trailing edge with respect to the centerline axis.

The heat exchanger of any preceding or any following clause, wherein the first annular fin defines a first trailing edge, and the second annular fin defines a second trailing edge, wherein at least one of the first trailing edge and the second trailing edge defines a plurality of circumferentially adjoining chevrons.

The heat exchanger of any preceding or any following clause, wherein the outer body defines an inner wall, and the first annular fin defines a radially outer surface, wherein a second flow channel is defined therebetween.

The heat exchanger of any preceding or any following clause, wherein the outer body defines a belly at a mid-line of the outer body, wherein the flow passage converges downstream from the belly and upstream from the outlet.

The heat exchanger of any preceding or any following clause, further comprising a diffuser body extending downstream from the inlet into the flow passage along the centerline axis.

The heat exchanger of any preceding or any following clause, wherein at least one of the first annular fin and the second annular fin includes a cooling circuit therein.

The heat exchanger of any preceding or any following clause, wherein the cooling circuit is fluidly coupled to a thermal fluid source.

The heat exchanger of any preceding or any following clause, wherein the heat exchanger is configured to mount within a flowpath of a gas turbine engine.

The heat exchanger of any preceding or any following clause, wherein the gas turbine engine includes a turbomachine exhaust nozzle, wherein the heat exchanger is configured to mount within the turbomachine exhaust nozzle.

A gas turbine engine, comprising: a fan duct; a heat exchanger, comprising: an outer body having a centerline axis and defining a flow passage extending from an inlet to an outlet of the heat exchanger, wherein the inlet is in fluid communication with the fan duct; a first annular fin disposed within the flow passage, wherein the first annular fin is concentrically aligned with the centerline axis and defines a first undulating surface; and a second annular fin disposed within the flow passage, wherein the second annular fin is concentrically aligned with the centerline axis and defines a second undulating surface, wherein the second annular fin is radially spaced from the first annular fin to define a flow channel therebetween, and wherein the flow passage, the first annular fin, and the second annular fin diverge along the centerline axis downstream from the inlet.

The heat exchanger of any preceding or any following clause, wherein the first undulating surface is aligned circumferentially and axially with the second undulating surface with respect to the centerline axis.

The heat exchanger of any preceding or any following clause, wherein the first undulating surface and the second undulating surface are undulated in an axial direction with respect to the centerline axis.

We claim:

1. A heat exchanger, comprising:
an outer body having a centerline axis and defining a flow passage extending from an inlet to an outlet of the heat exchanger;
a first annular fin disposed within the flow passage, wherein the first annular fin is concentrically aligned with the centerline axis and defines a first undulating surface; and
a second annular fin disposed within the flow passage, wherein the second annular fin is concentrically aligned with the centerline axis and defines a second undulating surface, wherein the second annular fin is radially spaced from the first annular fin to define a flow channel therebetween, and wherein the flow passage, the first annular fin, and the second annular fin diverge along the centerline axis downstream from the inlet.

2. The heat exchanger of claim 1, wherein the outer body is bulbous shaped between the inlet and the outlet.

3. The heat exchanger of claim 1, wherein the first undulating surface is aligned circumferentially and axially with the second undulating surface with respect to the centerline axis.

4. The heat exchanger of claim 1, wherein the first undulating surface and the second undulating surface are undulated in an axial direction with respect to the centerline axis.

5. The heat exchanger of claim 1, wherein the first undulating surface and the second undulating surface are undulated in a circumferential direction with respect to the centerline axis.

6. The heat exchanger of claim 1, wherein the first annular fin and the second annular fin are formed to turn flow of a first fluid through the flow channel about the centerline axis.

7. The heat exchanger of claim 1, wherein the first annular fin defines a first leading edge, and the second annular fin defines a second leading edge, wherein the first leading edge is axially offset from the second leading edge with respect to the centerline axis.

8. The heat exchanger of claim 1, wherein the first annular fin defines a first leading edge, and the second annular fin defines a second leading edge, wherein at least one of the first leading edge and the second leading edge defines a plurality of circumferentially adjoining chevrons.

9. The heat exchanger of claim 1, wherein the first annular fin defines a first trailing edge, and the second annular fin defines a second trailing edge, wherein the first trailing edge is axially offset from the second trailing edge with respect to the centerline axis.

10. The heat exchanger of claim 1, wherein the first annular fin defines a first trailing edge, and the second annular fin defines a second trailing edge, wherein at least one of the first trailing edge and the second trailing edge defines a plurality of circumferentially adjoining chevrons.

11. The heat exchanger of claim 1, wherein the outer body defines an inner wall, and the first annular fin defines a radially outer surface, wherein a second flow channel is defined therebetween.

12. The heat exchanger of claim 1, wherein the outer body defines a belly at a mid-line of the outer body, wherein the flow passage converges downstream from the belly and upstream from the outlet.

13. The heat exchanger of claim 1, further comprising a diffuser body extending downstream from the inlet into the flow passage along the centerline axis.

14. The heat exchanger of claim 1, wherein at least one of the first annular fin and the second annular fin includes a cooling circuit therein.

15. The heat exchanger of claim 14, wherein the cooling circuit is fluidly coupled to a thermal fluid source.

16. The heat exchanger of claim 1, wherein the heat exchanger is configured to mount within a flowpath of a gas turbine engine.

17. The heat exchanger of claim 16, wherein the gas turbine engine includes a turbomachine exhaust nozzle, wherein the heat exchanger is configured to mount within the turbomachine exhaust nozzle.

18. A gas turbine engine, comprising:
a fan duct;
a heat exchanger, comprising:
an outer body having a centerline axis and defining a flow passage extending from an inlet to an outlet of the heat exchanger, wherein the inlet is in fluid communication with the fan duct;
a first annular fin disposed within the flow passage, wherein the first annular fin is concentrically aligned with the centerline axis and defines a first undulating surface; and
a second annular fin disposed within the flow passage, wherein the second annular fin is concentrically aligned with the centerline axis and defines a second undulating surface, wherein the second annular fin is radially spaced from the first annular fin to define a flow channel therebetween, and wherein the flow passage, the first annular fin, and the second annular fin diverge along the centerline axis downstream from the inlet.

19. The heat exchanger of claim 17, wherein the first undulating surface is aligned circumferentially and axially with the second undulating surface with respect to the centerline axis.

20. The heat exchanger of claim 17, wherein the first undulating surface and the second undulating surface are undulated in an axial direction with respect to the centerline axis.
